(19) United States
(12) Patent Application Publication
(10) Pub. No.: US 2010/0306049 A1
(43) Pub. Date: Dec. 2, 2010

(54) METHOD AND SYSTEM FOR MATCHING ADVERTISEMENTS TO WEB FEEDS

(75) Inventors: Vinay Kakade, Santa Clara, CA (US); Lance Riedel, Menlo Park, CA (US); Prasenjit Sarkar, Santa Clara, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/475,846

(22) Filed: Jun. 1, 2009

(51) Int. Cl. G06Q 30/00; G06F 17/30

(52) U.S. Cl. 705/14.49; 705/26; 707/E17.108

(57) ABSTRACT

A system for serving advertisements in a networked environment includes a web feed ad server operable to receive web feed information, identify concept terms in the web feed information, match advertisements to the concept terms, and communicate the advertisement to a terminal. Concept terms are identified by comparing terms in the web feed to information in an encyclopedia database, a product listing database, and/or a bidded keyword database. Rewrites associated with the concept terms are generated by a sponsored search ad system. The concept terms and rewrites are placed in a document and communicated to a context matching ad system operable to match an advertisement to the content of the document.

### BACKGROUND

The Internet has emerged as a powerful advertising tool. It is commonplace to see advertisements on many web sites. For example, advertisements may be displayed on search web sites and may be targeted to users based upon search terms provided by the users. Other web sites, such as news and sports web sites, may also provide space for advertisements. On these web sites, advertisements may be matched based on the content displayed on the web site. The owners of these web sites may monetize the web sites by selling advertising space to advertisers.

Social networking web sites, such as LinkedIn® and Facebook®, are a relatively new phenomenon and are gaining popularity. These web sites typically enable users to communicate as a group. Typically, a user registers with the web site, and in doing so, provides information that enables matching the user to other users. For example, a user may specify the high school he attended. The web site then matches that user with other users who attended the same high school. Once matched, users may communicate to one another via email or web feed. Web feeds are typically broadcast to a number of users at the same time and are typically used to provide updated information to a group of users.

Blogs are another relatively new phenomenon on the Internet. Blogs are websites that are usually maintained by an individual. They are typically utilized to provide regular commentary on a subject, such as news on a particular subject. Typically, users can subscribe to blogs that are updated via a web feed, which is a data format utilized on the Internet for providing users with frequently updated content.

One problem with existing social networking web sites and blogs is that they provide limited opportunity for monetization. One reason for this is that it is difficult to provide the kind of targeted advertising that is available with other web sites, such as sponsored search web sites or web sites that match advertisements based on the content of the web site. For example, systems like Google's AdSense® rely on web pages being homogeneous to display the ads. However, these systems do not work well with social networking web sites and blogs because often times the information on the social networking website and/or in the blog is not homogeneous.

### BRIEF DESCRIPTION OF THE DRAWINGS

FIG. 1 shows a web feed ad server system for serving advertisements related to web feeds;

FIG. 2 is a flow chart of operations performed by a web feed ad server system;

FIG. 3 is a flow chart for identifying concept terms embedded in a topic;

FIG. 4 is a flow chart for generating a document from combined terms and rewrites;

FIG. 5 illustrates a screenshot of an exemplary blog that receives data in the form of a web feed;

FIG. 6 illustrates first, second, and third exemplary web feed elements; and

FIG. 7 illustrates a general computer system, which may represent any of the computing devices referenced herein.

### DETAILED DESCRIPTION

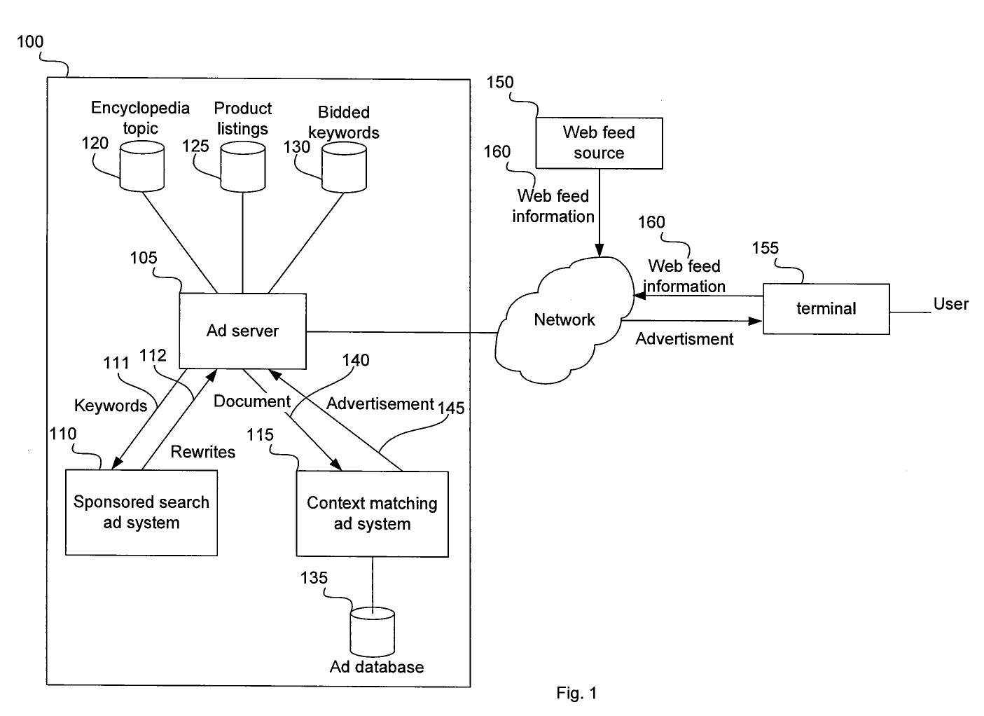

The embodiments below describe a system for matching an advertisement to a web feed and/or blog and serving the matched advertisement to a terminal. Generally, a web feed is a data format utilized on the Internet for providing users with frequently updated content. Users typically subscribe, either knowingly or unknowingly, to a system that communicates the web feed to all the subscribers of the web feed. For example, referring to FIG. 1, the user of a terminal 155 may subscribe to a web feed generated by a web feed source 150. The web feed source 150 may then communicate the web feed to the terminal 155 whenever the content of the web feed is updated.

The source of the web feed content may be generated by a person or a machine. For example, the web feed information may simply be information that a user of a social network wants other users to know about. For instance, a user registered on Facebook® may be traveling around the world and may want to update other users in his social network as to his whereabouts. In this case, the other users will periodically receive activity web feed information including content written by the travelling user each time he updates the information.

The web feed content may also, for example, correspond to a news report. For example, a user may subscribe to a Really Simple Syndication (RSS) generating an RSS feed that includes news content. Every time the news content updates, the RSS feed may be communicated to the user.

Web feeds may include one or more web feed elements. For example, an RSS feed for a blog is a web feed, while each individual blog entry is a web feed element. A Facebook® activity stream is a web feed, while each individual activity is a web feed element.

As noted above, blogs are usually maintained by an individual. They are typically utilized to provide regular commentary on a subject, such as news on a particular subject. In some cases, each blog entry may be about a different topic.

FIG. 1 shows a web feed ad server system 100 for serving advertisements related to web feeds. The web feed ad server system 100 includes a web feed ad server 105, a sponsored search ad system 110, and a context matching ad system 115. The web feed ad server system 100 also includes an encyclopedia topic database 120, a product-listing database 125, a bidded keywords database 130, and an advertisement database 135.

The web feed ad server 105, sponsored search ad system 110, and context matching ad system 115 may correspond to any generalized computing device, such as an Intel®, AMD®, and/or PowerPC® based computer running an operating system, such as a Microsoft Windows®, Linux®, and/or Unix® operating system. The web feed ad server 105, sponsored search ad system 110, and context matching ad system 115 may be adapted to communicate with other computers and each other via an interface, such as a network interface. The functionality associated with the web feed ad server 105, sponsored search ad system 110, and context matching ad system 115 may reside on a single computing device or be distributed among multiple computing devices.

The web feed ad server 105 may also be adapted to receive web feed information 160 from a terminal 155 and/or the web feed source 150 and communicate an advertisement to the terminal 155. The web feed information 160 may correspond to a Really Simple Syndication (RSS) feed, an activity feed, or other type of feed information. For example, the web feed information 160 may correspond to a communication initiated by a user via a social network, such as Facebook® or LinkedIn®. The web feed information 160 may include information about recent activities that the user has undertaken. For example, the web feed information 160 may include a comment from the user that the user has purchased a new product, such an Apple® IPhone®. The web feed ad server 105 may analyze the web feed information 160 to determine whether there may be any monetizable concept terms embedded within the web feed information 160. A web feed includes monetizable concept terms when a correlation exists between advertisements and the web feed. For example, an advertisement for an IPhone® may be correlated with the exemplary activity feed described above.

The encyclopedia topic database 120, product listing database 125, bidded keywords database 130, and advertisement database 135 may reside in a memory adapted to store a database, such as a hard drive. The respective databases may be integrated into the web feed ad server system 100, as shown. Alternatively, the respective databases may reside in external systems interconnected with the web feed ad server system 100 via a network, such as the Internet.

The encyclopedia topic database 120 may include data that defines an encyclopedia that can be indexed via a topic. In some embodiments, the web feed ad server system 100 may communicate with an encyclopedia database server, such as Wikipedia, to retrieve encyclopedia information instead of or in addition to the encyclopedia topic database 120. At least one advantage to this approach is that it frees an operator of the web feed ad server system 100 from having to maintain an encyclopedia topic database, such as the encyclopedia topic database 120 of FIG. 1

The product listing database 125 may include data that defines products that are sold, for example, by online retailers. For example, the product listing database 125 may include details such as the manufacturer and model number of a specific product. In some embodiments, the web feed ad server system 100 may communicate with an online retail system, such as Yahoo Shopping®, to retrieve the product listing information instead of or in addition to the product-listing database 125. At least one advantage to this approach is that it frees an operator of the web feed ad server system 100 from having to maintain a product listing database, such as the product listing database 125 of FIG. 1.

The bidded keywords database 130 may include data that defines terms that online advertisers place bids on. For example, the bidded keywords database 130 may include details such as terms, the frequency with which advertisers bid on the terms, and the price advertisers pay for the terms. In some embodiments, the web feed ad server system 100 may communicate with the bidded keywords database 130 as shown in FIG. 1. In alternative embodiments, the web feed ad server 105 may retrieve information associated with bidded keywords from a sponsored search ad system 110 or context matching ad system 115, such as those shown in FIG. 1. These systems may include one or more databases that include bidded keyword information. At least one advantage to this approach is that it frees an operator of the web feed ad server system 100 from having to maintain a bidded keywords database, such as the bidded keywords database 130 of FIG. 1.

The sponsored search ad system 110 may correspond to or be part of a system adapted to communicate an advertisement related to a keyword 111, specified by a user, to a terminal 155. For example, the sponsored search ad system 110 may correspond to a search engine web server, or a back-end server operating in conjunction with the search engine web server, adapted to search through an advertisement database for advertisements associated with keywords 111. The sponsored search ad system 110 may be adapted to identify terms related to the specified keyword 111, to improve the likelihood of finding an advertisement related to the keyword 111. The related terms are hereinafter referred to as rewrites 112. For example, the sponsored search ad system 110 may expand the search term “DVD” into the rewrites 112 “blue ray,”, “CD,” and “electronics.” This may result in better targeting of advertisements to the user that specified the keyword “DVD.” The sponsored search ad system 110 may also be adapted to receive keywords 111 from the web feed ad server 105, and communicate a list of monetizable rewrites 112 associated with the keyword back to the web feed ad server 105.

The context matching ad system 115 may correspond to a system that matches advertisements to web pages based on the content of the web page. For example, the context matching ad system 115 may correspond to an ad server or back-end server operating in conjunction with the ad server adapted to search through information that defines a web page, such as the meta-data of the web page, and identify monetizable content of the web page, which corresponds to content to which advertisers are willing to target advertisements. For example, the context matching ad system 115 may associate a cellular telephone carrier advertisement with a web page displaying a review of cell phones from various cell phone manufactures. The context matching ad system 115 may be adapted to receive a document 140 that includes data related to the web feed information 160 from the web feed ad server 105. The context matching ad system 115 may then identify and communicate to the web feed ad server 105 advertisements 145 related to the content of the document.

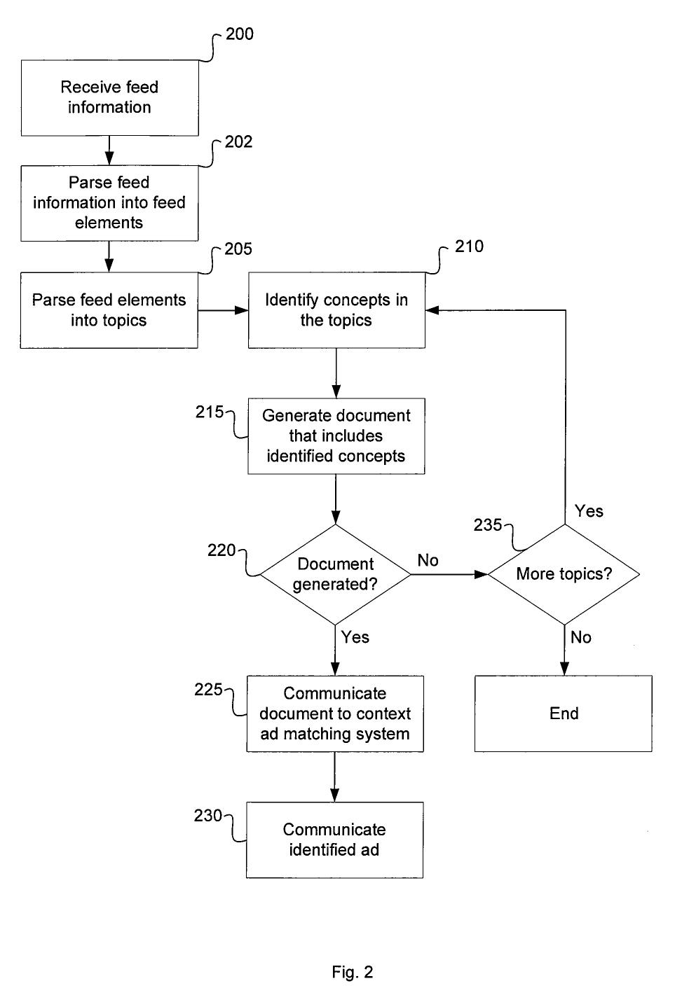

FIG. 2 is a flow chart of operations performed by the web feed ad server system 100 of FIG. 1. At block 200, web feed information may be received. For example, web feed information 160 may be communicated to the web feed ad server 105 from the terminal 155 or the web feed source 150. The web feed information 160 may correspond to an RSS feed, a feed of twitter updates, a blog, a news feed, a social network feed, or any other information.

At block 202, the web feed information may be parsed into web feed elements. For example, individual blog entries in an RSS feed may correspond to web feed elements. In an activity stream, such as a Facebook® activity stream, individual activities may correspond to web feed elements.

At block 205, the web feed elements may be parsed into topics. For example, the web feed element may correspond to one or more sentences strung together, where the subject of each sentence may or may not be different. The web feed ad server 105 may parse the various sentences into individual topics.

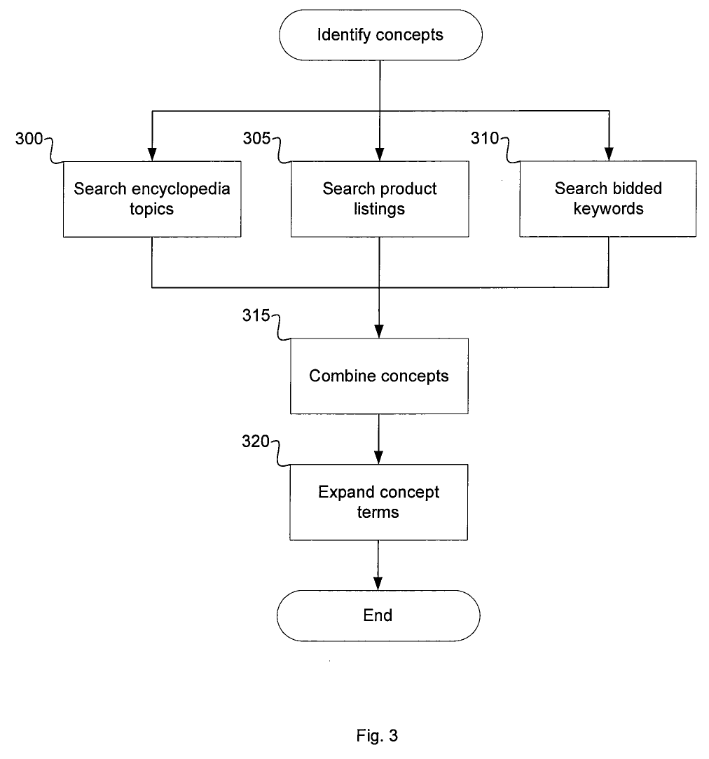

At block 210, concept terms embedded within the topics may be identified. FIG. 3 is a flow chart for identifying concept terms embedded in a topic. Referring to FIG. 3, at block 300, a web feed ad server, such as the web feed ad server 105 of FIG. 1, may search through an encyclopedia database 120 for the topic to identify phrases associated with the topic. Alternatively, the web feed ad server may communicate and search for the topic on an online encyclopedia, such as Wikipedia.

At block 305, the topic may be compared to items in a product listing. For example, the web feed ad server 105 of FIG. 1 may search through the product listing database 125 to determine whether the topic includes any terms that may correspond to products that are sold online. For instance, a term defining a specific model number of a DVD player manufactured by Sony® may be identified because that specific DVD player is listed in the product listing database 125. Alternatively, the topic may be communicated to an online shopping system, such as Yahoo Shopping®, and the online shopping system may return product listings associated with the topic.

At block 310, the topic may be compared to keywords that advertisers bid on. For example, referring to FIG. 1, the web feed ad server 105 may search through the bidded keywords database 130 to determine whether the topic includes any terms matching bidded keywords. For instance, the term “automobile” may be identified if the topic “Automobile” corresponds to a keyword that many advertisers bid on. Alternatively, the topic may be communicated to a sponsored search ad system, such as Yahoo! Search® and/or a context based ad matching system, such as Yahoo! Sponsored Search. The respective system may then return keywords associated with the topic.

At block 315, the concept terms returned at blocks 300, 305, and 310 are combined.

At block 320, the combined terms are expanded to include other related terms. For example, rewrites of the combined terms are generated. For instance, the web feed ad server system 100 of FIG. 1 may communicate the combined terms to the sponsored search ad system 110. The sponsored search ad system 110 may then return one or more rewrites that are related to the combined terms.

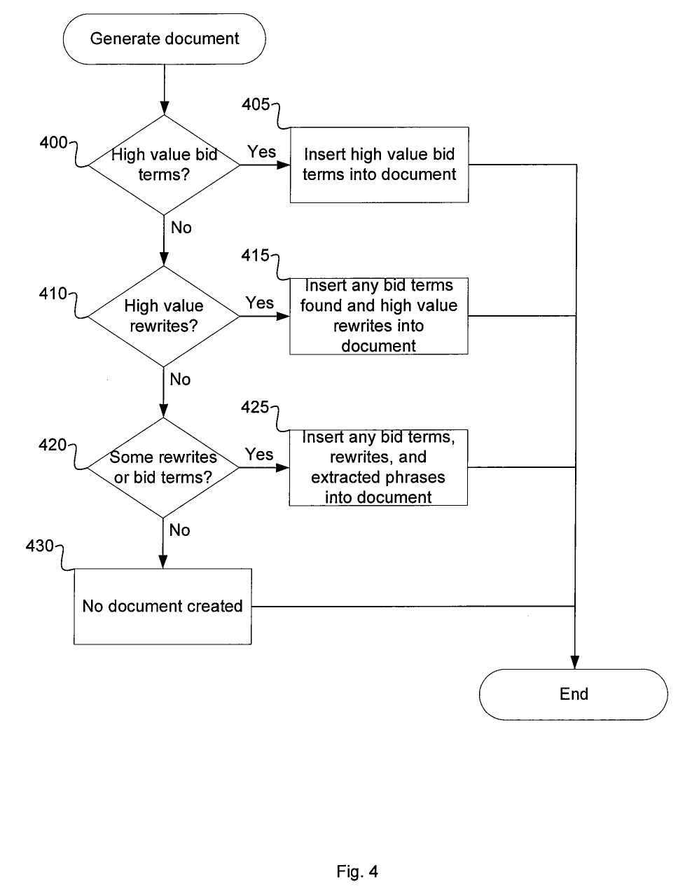

Referring back to FIG. 2, at block 215, the combined terms and rewrites, if any, may be utilized to generate a file, such as a document, that includes monetizable concept terms. FIG. 4 is a flow chart for generating a document from the combined terms and rewrites.

Referring to FIG. 4, at block 400, if the combined terms and rewrites correspond to high value bid terms, then at block 405, the high value bid terms may be inserted into a document and subsequently processed by the context ad matching system. Bid terms are words that advertisers bid on. Typically, the advertiser that places the highest bid will have his advertisement associated with the term when the term is located on a web page. For example, the terms may correspond to search terms entered by a user on a sponsored search system, such as Yahoo! Search. The advertisement associated with the highest bid may be displayed to the user along with the search results.

High value bid terms correspond to those bid terms for which advertiser's are willing to pay a premium. For example, an advertiser may be willing to pay more for the bid term “IPhone” than a more generic bid term such as “phone” because the bid term is more specific. The presence of high value bid terms increases the probability that an advertisement will be matched. Moreover, because the high value bid term was found, a matched advertisement may be highly related to the web feed. As a result, there may be no need to insert any other terms into the document.

If, at block 400, the combined terms and rewrites do not contain high value bid phrases, then at block 410, if the combined terms and rewrites include high value rewrites, then at block 415 the rewrites and/or and bid terms may be inserted into a document and subsequently processed by the context ad matching system. High value rewrites correspond to bid terms for which an advertiser's is willing to pay a premium. The probability of matching an advertisement to a rewrite is high. However, the relatedness between a matched advertisement and the web feed may be less than when high value bid terms are present. As such, high value rewrites are generally given a lower priority in the document creation process.

If, at block 410, the concept terms do not contain high value rewrites, then at block 420, if there are any rewrites, bid terms, or phrases, then at block 425, the rewrites, bid terms, and/or phrases are inserted into the document and the document may be processed.

If, at block 420, no bid terms or rewrites are identified in the concept, then at block 430 no document is returned for processing. Returning to FIG. 2, at block 220, if a document was generated via the operations above, then at block 225, the document may be communicated to a context based ad matching system, such as the context matching ad system 115 of the FIG. 1. As described above, the context matching ad system 115 may then search through the document for monetizable content.

At block 230, an advertisement associated with monetizable content identified at block 225 may be located and communicated to a terminal. For example, referring to FIG. 1, the context matching ad system 115 may identify an advertisement in the ad database 135 that matches monetizable concept terms in the document 140. The context matching ad system 115 may then communicate the identified advertisement 145 to the web feed ad server 105. The web feed ad server 105 may then communicate the advertisement to a browser operating on a terminal 155.

Referring back to block 220, if no document is generated, then at block 235, if more topics exist in the web feed information, then the operations at block 210 may be repeated.

If at block 235 no more topics exist, then the operations end.

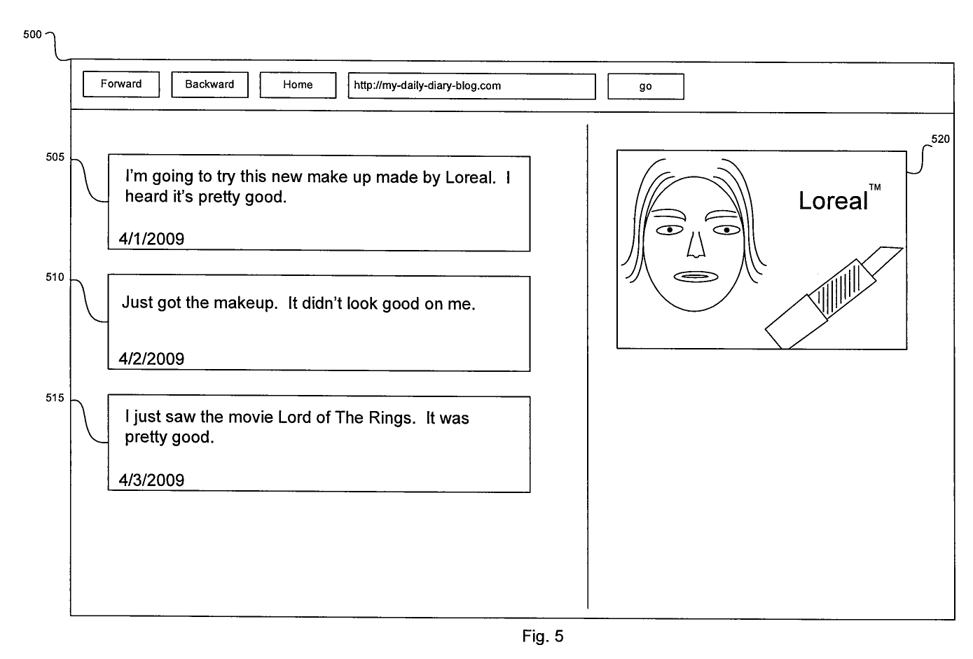

FIG. 5 illustrates a screenshot of an exemplary blog 500 that receives data in the form of a web feed. The exemplary blog 500 corresponds to a diary maintained by an individual. The exemplary blog 500 includes first, second, and third web feed entries 505, 510, and 515. Also shown is an exemplary advertisement 500.

The blog may be analyzed according to the operations described above in FIG. 4. Each of the web feed entries 505, 510, and 515 may correspond to a web feed element. The location at which the advertisement 520 is placed may be reserved for advertisements that are related to information in the web feed elements. For example, the exemplary advertisement 520 may be have been placed because it is related to the first web feed element 505. Targeting advertisements based on information in the web feed allows for monetization of the blog.

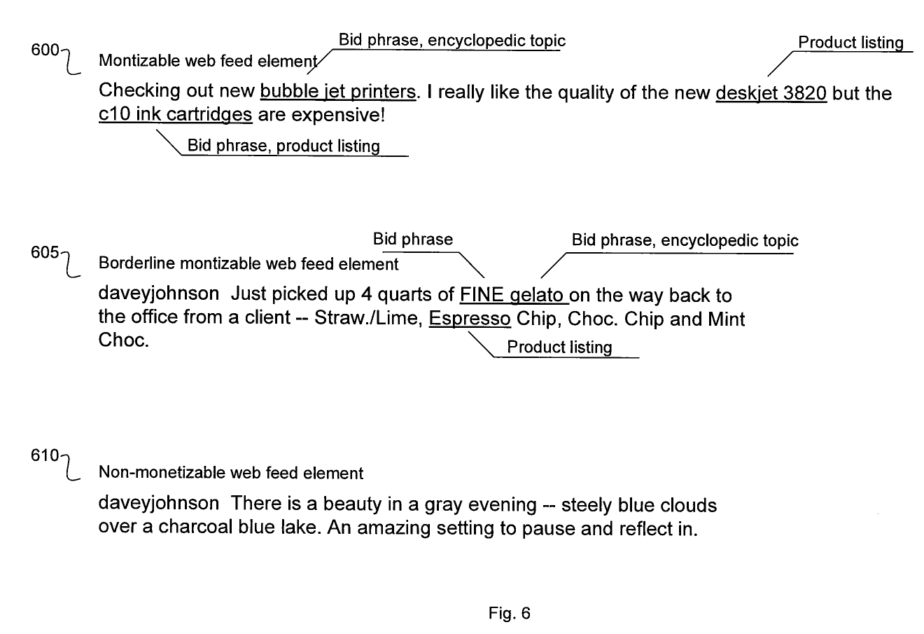

FIG. 6 illustrates first, second, and third exemplary web feed elements 600, 605, and 610. The first exemplary web feed element 600 corresponds to a highly monetizable web feed element. In this case, the first exemplary web feed element 600 is highly monetizable because it incorporates several concept terms that are related to bid phrases and product listings. The second exemplary web feed element 605 corresponds to a moderately monetizable web feed element because the number of identified bid phrases and product listings is less than in the first exemplary web feed element 600. The third exemplary web feed element is not monetizable because it lacks any monetizable concept terms.

The advantage of the operations described in FIG. 2-4 become apparent when one considers that the turnaround time between receiving a web feed and serving an advertisement should be as fast as possible. For example, in some embodiments the operations described in FIG. 2 may terminate once a topic with a monetizable concept term is located. That is, further topics may not necessarily be analyzed. This will necessarily save processing time.

In addition, the operations of FIG. 4 are arranged to produce the most monetizable output in the shortest time. For example, if any high value bid terms (bid terms for which an advertiser is willing to pay a premium) are determined to be associated with the topic, a document may be created based solely on those high value bid terms and subsequently analyzed by the content ad matching system. This may result in a document that is guaranteed to be monetizable. The size of document may also be relatively small because it only includes high value bid terms, and no rewrites or phrases. This allows the context ad matching system to scan the document more quickly and match a suitable ad.

The operations of FIG. 4 may also be modified to allow an operator to set a threshold for advertisement placement. For example, an operator may allow the document to include any rewrites and bid terms. This may result in more frequent placement of advertisements than if the operator were to allow only documents with high value bid terms. However, this may decrease the relatedness between the advertisement and the web feed information. Controlling the information placed in the document enables the operator to control the aggressiveness of the advertisement placement.

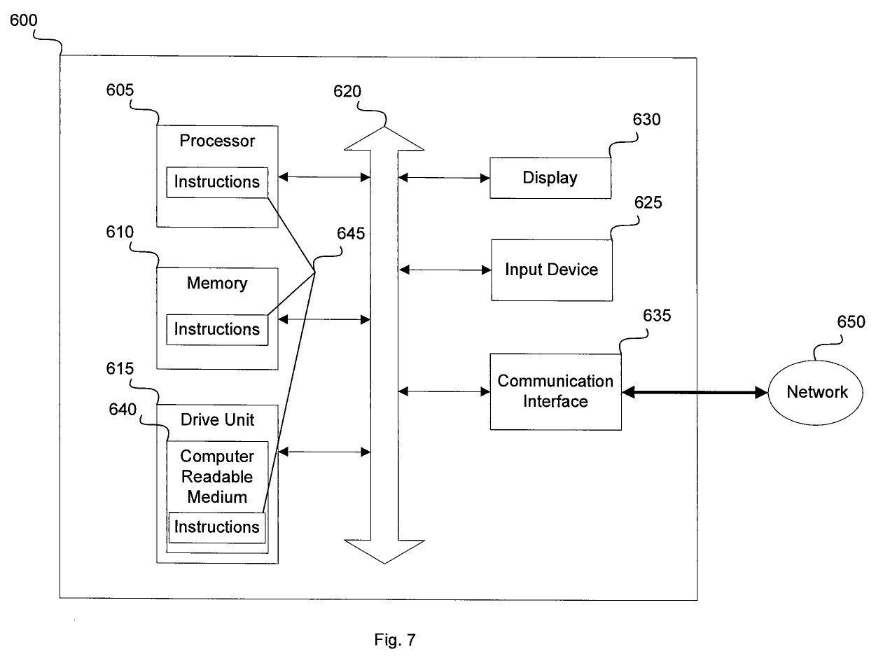

FIG. 7 illustrates a general computer system 700, which may represent the web feed ad server 105, the sponsored search ad system processor 110, and the context matching ad system 115 of FIG. 1, or any of the other computing devices referenced herein. The computer system 700 may include a set of instructions 745 that may be executed to cause the computer system 700 to perform any one or more of the methods or computer-based functions disclosed herein. The computer system 700 may operate as a stand-alone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 745 (sequential or otherwise) that specify actions to be taken by that machine. In one embodiment, the computer system 700 may be implemented using electronic devices that provide voice, video or data communication. Further, while a single computer system 700 may be illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 705, such as a central processing unit (CPU), a graphics processing unit (GPU), or both. The processor 705 may be a component in a variety of systems. For example, the processor 705 may be part of a standard personal computer or a workstation. The processor 705 may be one or more general processors, digital signal processors, application specific integrated circuits, field programmable gate arrays, servers, networks, digital circuits, analog circuits, combinations thereof, or other now known or later-developed devices for analyzing and processing data. The processor 705 may implement a software program, such as code generated manually (i.e., programmed).

The computer system 700 may include a memory 710 that can communicate via a bus 720. For example, the advertisement encyclopedia database 120, product listing database 125, and bidded keywords database 130 may be stored in the memory. The memory 710 may be a main memory, a static memory, or a dynamic memory. The memory 710 may include, but may not be limited to, computer readable storage media such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one case, the memory 710 may include a cache or random access memory for the processor 705. Alternatively or in addition, the memory 710 may be separate from the processor 705, such as a cache memory of a processor, the system memory, or other memory. The memory 710 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 710 may be operable to store instructions 745 executable by the processor 705. The functions, acts or tasks illustrated in the figures or described herein may be performed by the programmed processor 705 executing the instructions 745 stored in the memory 710. The functions, acts or tasks may be independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 700 may further include a display 730, such as a liquid crystal display (LCD), an organic light emitting diode (OLED), a flat panel display, a solid state display, a cathode ray tube (CRT), a projector, a printer or other now known or later-developed display device for outputting determined information. The display 730 may act as an interface for the user to see the functioning of the processor 705, or specifically as an interface with the software stored in the memory 710 or in the drive unit 715.

Additionally, the computer system 700 may include an input device 725 configured to allow a user to interact with any of the components of system 700. The input device 725 may be a number pad, a keyboard, or a cursor control device, such as a mouse, or a joystick, touch screen display, remote control or any other device operative to interact with the system 700.

The computer system 700 may also include a disk or optical drive unit 715. The disk drive unit 715 may include a computer-readable medium 740 in which one or more sets of instructions 745, e.g. software, can be embedded. Further, the instructions 745 may perform one or more of the methods or logic as described herein. The instructions 745 may reside completely, or at least partially, within the memory 710 and/or within the processor 705 during execution by the computer system 700. The memory 710 and the processor 705 also may include computer-readable media as discussed above.

The present disclosure contemplates a computer-readable medium 740 that includes instructions 745 or receives and executes instructions 745 responsive to a propagated signal, so that a device connected to a network 750 may communicate voice, video, audio, images or any other data over the network 750. The instructions 745 may be implemented with hardware, software and/or firmware, or any combination thereof. Further, the instructions 745 may be transmitted or received over the network 750 via a communication interface 735. The communication interface 735 may be a part of the processor 705 or may be a separate component. The communication interface 735 may be created in software or may be a physical connection in hardware. The communication interface 735 may be configured to connect with a network 750, external media, the display 730, or any other components in system 700, or combinations thereof. The connection with the network 750 may be a physical connection, such as a wired Ethernet connection or may be established wirelessly as discussed below. Likewise, the additional connections with other components of the system 700 may be physical connections or may be established wirelessly.

The network 750 may include wired networks, wireless networks, or combinations thereof. The wireless network may be a cellular telephone network, an 802.11, 802.17, 802.20, or WiMax network. Further, the network 750 may be a public network, such as the Internet, a private network, such as an intranet, or combinations thereof, and may utilize a variety of networking protocols now available or later developed including, but not limited to, TCP/IP based networking protocols.

The computer-readable medium 740 may be a single medium, or the computer-readable medium 740 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 740 may include a solid-state memory such as a memory card or other package that houses one or more non-volatile read-only memories. The computer-readable medium 740 also may be a random access memory or other volatile re-writable memory. Additionally, the computer-readable medium 740 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the methods described herein and which, when loaded in a computer system, is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As shown above, the web feed ad server system enables operators of a social networking web site, or any website that includes web feed information, to provide high level targeting of advertisements, which improves monetization of the web site. For example, in one embodiment the web feed ad server 105, receives web feed information 160. The web feed ad server 105 then identifies concept terms in the web feed information 160 by comparing the web feed information 160 with encyclopedia information, product listing information, and bidded keyword information. The identified concept terms are expanded to include rewrites by a sponsored search ad system.

After the concept terms are identified, a document that includes one or more of the concept terms is generated and communicated to a context matching ad system 115. The context matching ad system 115 matches an advertisement to the content of the document and communicates the advertisement back to the web feed ad server 105, which then communicates the advertisement back to a terminal 155.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A method for serving advertisements in a networked environment, the method comprising:
receiving, at a web feed ad server, information associated with a web feed;
identifying concept terms in the information;
matching the identified concepts to an advertisement; and
communicating the advertisement to a browser.

2. The method according to claim 1, further comprising:
parsing the information associated with the web feed into one or more topics; and
identifying concept terms in the one or more topics.

3. The method according to claim 1, further comprising comparing terms in the information with a database that includes at least one of: encyclopedic information, product listing information, and bidded keyword information, to identify concept terms.

4. The method according to claim 3, further comprising generating rewrites associated with the identified concept terms.

5. The method according to claim 4, further comprising:
communicating the identified concept terms from the web feed ad server to a sponsored search ad matching system;
determining, by the sponsored search ad system, rewrites associated with the concept terms; and
communicating the rewrites to the web feed ad server.

6. The method according to claim 1, further comprising generating a document including the identified concept terms.

7. The method according to claim 6, wherein the document includes bid terms when identified concepts are associated with bid terms for which advertisers pay a premium.

8. The method according to claim 6, wherein the document includes bid terms and rewrites when the identified concept terms are associated with rewrites for which advertisers pay a premium.

9. The method according to claim 6, wherein the document includes bid terms, rewrites, and extracted phrases when the identified concept terms are associated with rewrites or bid terms.

10. The method according to claim 6, further comprising:
communicating the document from the web feed ad server to a context matching ad system;
identifying, by the context matching ad system, an advertisement that matches content of the document;
communicating the identified advertisement to the web feed ad server.

11. A system for serving advertisements in a networked environment, the system comprising:
a web feed ad server operable to receive information associated with a web feed and identify concept terms in the information; and
a context matching ad system operable to match an identified concept to an advertisement, wherein the web feed ad server is operable to communicate the advertisement to a browser.

12. The system according to claim 11, wherein the web feed ad server is operable to parse the information associated with the web feed into one or more topics, and identify concept terms in the one or more topics.

13. The system according to claim 11, wherein the web feed ad server is operable to compare terms in the information with a database that includes at least one of: encyclopedic information, product listing information, and bidded keyword information, to identify concept terms.

14. The system according to claim 13, further comprising a sponsored search ad system operable to generate rewrites associated with the identified concept terms.

15. The system according to claim 14, wherein:
the web feed ad server is operable to communicate the identified concept terms to the sponsored search ad matching system;
the sponsored search is operable to determine rewrites associated with the concept terms, and communicating the rewrites to the web feed ad server.

16. The system according to claim 11, wherein the web feed ad server is operable to generate a document including the identified concept terms.

17. The system according to claim 16, wherein the document includes bid terms when identified concepts are associated with bid terms for which advertisers pay a premium.

18. The system according to claim 16, wherein the document includes bid terms and rewrites when the identified concept terms are associated with rewrites for which advertisers pay a premium.

19. The system according to claim 16, wherein the document includes bid terms, rewrites, and extracted phrases when the identified concept terms are associated with either rewrites or bid terms.

20. The system according to claim 16, wherein:
the web feed ad server is operable to communicate the document to the context matching ad system; and
the context matching ad system is operable to identify advertisements that match content of the document, and communicate the identified advertisement to the web feed ad server.

21. A machine-readable storage medium having stored thereon a computer program comprising at least one code section for serving advertisements in a networked environment, the at least one code section being executable by a machine for causing the machine to perform acts of:
receiving, at a web feed ad server, information associated with a web feed;
identifying concept terms in the information;
matching an identified concept to an advertisement; and
communicating the advertisement to a browser.

22. The machine-readable storage according to claim 21, wherein the at least one code section comprises code that enables:
parsing the information associated with the web feed into one or more topics; and
identifying concept terms in the one or more topics.

23. The machine-readable according to claim 21, wherein the at least one code section comprises code that enables comparing terms in the information with a database that includes at least one of: encyclopedic information, product listing information, and bidded keyword information, to identify concept terms.

24. The machine-readable storage according to claim 21, wherein the at least one code section comprises code that enables generating a document including the identified concept terms.

25. The machine-readable storage according to claim 24, wherein the at least one code section comprises code that enables:
communicating the document from the web feed ad server to a context matching ad system;
identifying, by the context matching ad system, advertisements that match content of the document;
communicating the identified advertisement to the web feed ad server.
